(19) United States
(12) Patent Application Publication
(10) Pub. No.: US 2005/0166051 A1
(43) Pub. Date: Jul. 28, 2005

(54) System and method for certification of a secure platform

(76) Inventor: Mark Buer, Gilbert, AZ (US)

Correspondence Address: CHRISTIE, PARKER & HALE, LLP, PO BOX 7068, PASADENA, CA, 91109-7068, US

(21) Appl. No.: 11/042,011

(22) Filed: Jan. 25, 2005

Related U.S. Application Data
(60) Provisional application No. 60/539,200, filed on Jan. 26, 2004.
(60) Provisional application No. 60/614,104, filed on Sep. 29, 2004.

(51) Int. Cl. H04L 9/00

(52) U.S. Cl. 713/173

(57) ABSTRACT

A certifying entity ensures that a secure platform is secure after it leaves the manufacturer through the use of one or more keys associated with the secure platform. To maintain the security of the secure platform, the keys may be maintained strictly within the secured portion of the secure platform or the cryptograph engine in the chip may encrypt the private key before the key is stored in the off-chip data memory. To provide a relatively efficient manner of manufacturing the secure platform, the RSA private key is not stored in the secure platform until after the secure platform leaves the manufacturing location.

### CROSS-REFERENCE TO RELATED APPLICATION(S)

This application claims the benefit of U.S. Provisional Patent Application No. 60/539,200, filed Jan. 26, 2004, and U.S. Provisional Patent Application No. 60/614,104, filed Sep. 29, 2004, the disclosure of each of which is hereby incorporated by reference herein.

### TECHNICAL FIELD

This application relates to data communications and, more specifically, to systems and methods for certifying a secure platform.

### BACKGROUND

A variety of security techniques are known for protecting information in and controlling the operation of a computing platform such as a personal computer (“PC”) or a server. For example, physical and/or cryptographic techniques may be employed to control access to the platform and to data stored in the platform.

Physical security techniques may include locating the platform in a secure location, locking the platform in an enclosure, protecting integrated circuits (i.e., chips) from invasive monitoring by encapsulating the chips in, for example, an epoxy.

Cryptographic techniques may include data encryption, decryption and/or authentication. Data encryption and decryption techniques may be used to prevent unauthorized applications or persons from accessing data stored in the PC. For example, security passwords that are used to only allow authorized users to access a PC are stored on the PC in an encrypted form.

Authentication techniques may be used to verify that a given set of data is authentic. For example, when a server receives a message from a remote client, authentication information may be provided with that request that serves to verify that the message is from a specific source. In this way, the server may ensure that only authorized clients may access the applications and data provided by the server.

In certain transactions between platforms it is desirable for one platform to be able to determine whether the other platform is secure. For example, in e-commerce applications one platform may conduct financial transactions with another platform such as withdrawing money from an account. Here, it is imperative that the platform requesting the money is authorized to do so. Hence, there should be some form of assurance that the requesting platform is sufficiently secure.

In view of the above, a need exists for effective techniques for ensuring that a computing device or platform is secure.

### SUMMARY

The invention relates to a system and method for certifying that a computing device is secure. For convenience, an embodiment of a system constructed or a method practiced according to the invention will be referred to herein simply as an “embodiment.”

In one aspect of the invention a certifying entity ensures that the computing device is secure after it leaves the manufacturer through the use of one or more keys associated with the computing device. For example, an RSA private/public key pair may be used to secure communications with or access to the computing device.

To maintain the security of the computing device, the RSA private key may be maintained strictly within a secured portion of the computing device. For example, the private key may only appear “in the clear” inside a chip on the computing device and that chip may be physically protected by, for example, encapsulation or other techniques. In the event the private key needs to be stored in a data memory located outside the chip, a cryptographic processor in the chip may encrypt the private key before the key is stored in the off-chip data memory.

In some embodiments, to provide a relatively efficient manner of manufacturing the computing device, the RSA private key is not stored in the computing device until after the computing device leaves a manufacturing location. As a result, the manufacturing location may not need to be as secure of an environment as may otherwise be required. Also, the manufacturing process may not need to be slowed down waiting for relatively long key generation algorithms to be performed.

### BRIEF DESCRIPTION OF THE DRAWINGS

These and other features, aspects and advantages of the present invention will be more fully understood when considered with respect to the following detailed description, appended claims and accompanying drawings, wherein:

FIG. 1 is a simplified block diagram of one embodiment of a system constructed in accordance with the invention;

FIG. 2 is a simplified block diagram of one embodiment of a system incorporating a trusted platform module constructed in accordance with the invention;

FIG. 3 is a simplified block diagram of one embodiment of a data processing system incorporating a trusted platform module system constructed in accordance with the invention;

FIG. 4 is a simplified block diagram of one embodiment of a trusted platform module constructed in accordance with the invention;

FIG. 5 is a simplified block diagram of one embodiment of manufacturing flow for a trusted platform module in accordance with the invention;

FIG. 6 is a simplified block diagram of one embodiment of chip manufacturer processing flow for a trusted platform module in accordance with the invention;

FIG. 7 is a simplified block diagram of one embodiment of OEM processing flow for a trusted platform module in accordance with the invention;

FIG. 8 is a simplified block diagram of one embodiment of OEM processing flow for a trusted platform module in accordance with the invention; and

FIG. 9 is a simplified block diagram of one embodiment of OEM processing flow for a trusted platform module in accordance with the invention.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus or method. Finally, like reference numerals denote like features throughout the specification and figures.

### DETAILED DESCRIPTION

The invention is described below, with reference to detailed illustrative embodiments. It will be apparent that the invention may be embodied in a wide variety of forms, some of which may be quite different from those of the disclosed embodiments. Consequently, the specific structural and functional details disclosed herein are merely representative and do not limit the scope of the invention.

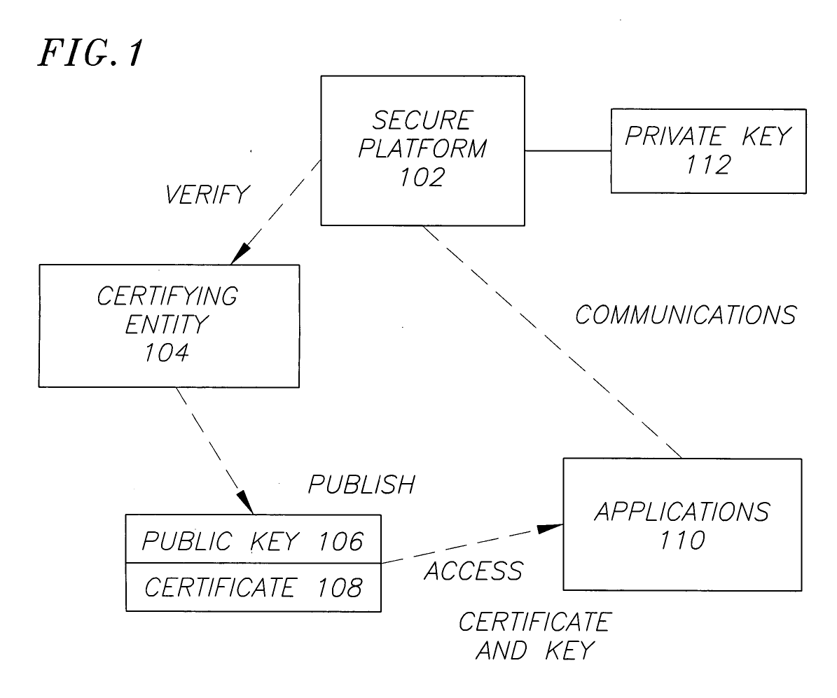

FIG. 1 depicts one embodiment of a system S where an application executing on a computing platform (e.g., device) may determine whether another computing platform is secure. The secure platform 102 includes one or more cryptographic processors (not shown) that may be used, for example, to protect data stored in the device or limit access to a data resource to authorized persons.

In one embodiment applications 110 may communicate with the secure platform 102 in a secure way using a public/private key protocol. For example, encrypted messages may be sent between an application and the secure platform where these messages are encrypted and decrypted using the public/private keys. In this case, the application uses a publicly available public key 106 portion of the key pair during these operations.

A certifying entity 104 generates a certificate 108 associated with the public key 106 thereby verifying that the secure platform is indeed secure and that the public key is authentic. For example, the certificate may serve to verify that the private key used by the secure platform was never exposed in an insecure environment. For example, the private key may be generated within a secure boundary in the secure platform and the secure platform may be designed such that the private key is never exposed in the clear outside the secure boundary of the platform. Alternatively, the private key may be injected into a secure boundary in the secure platform in a secure environment (e.g., within a hardware security module). In this case, the certificate may serve to verify that this environment was indeed secure.

Typically, the certificate is issued from a trusted source such as the manufacturer of the secure platform, an OEM manufacturer or by a commercial certificate vendor such as Verisign. Since the certificate is obtained from a known, trusted source, the application may be assured that the platform is secure.

In accordance with one embodiment of a system constructed according to the invention a certifying entity may ensure that the secure platform is secure after it leaves the manufacturer through the use of one or more keys associated with the secure platform. For example, an RSA private/public key pair may be used to secure communications with or access to the secure platform.

To maintain the security of the secure platform, the RSA private key 112 is maintained strictly within the secured portion of the secure platform. For example, the private key may only appear “in the clear” inside a chip including one or more cryptographic processors on the secure platform 102. In addition, that chip may be physically protected by, for example, tamper resistant techniques and/or tamper evident techniques. In the event the private key needs to be stored in a data memory located outside the chip, a cryptographic processor in the chip may encrypt the private key before the key is stored in the off-chip data memory.

In accordance with one embodiment of a system constructed according to the invention, to provide a relatively efficient manner of manufacturing the secure platform, the RSA private key may not be stored in the secure platform until after the chip and/or the secure platform leaves the respective manufacturing location. As a result, the manufacturing location may not need to be as secure of an environment as may otherwise be required. Also, the manufacturing process may not need to be slowed down waiting for relatively long key generation algorithms to be performed.

The above aspects of the invention will be discussed in more detail in conjunction with one embodiment of a trusted platform module constructed in accordance with the TPM specifications of the Trusted Computing Group (“TCG”). It should be understood, however, that the teachings of the invention are applicable to a variety of implementations and are not limited to a trusted platform module.

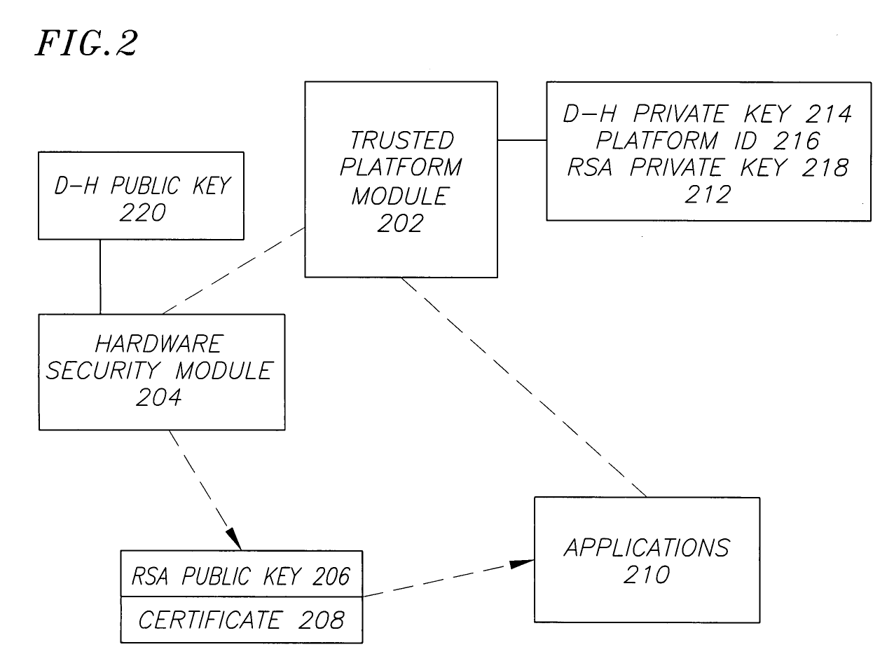

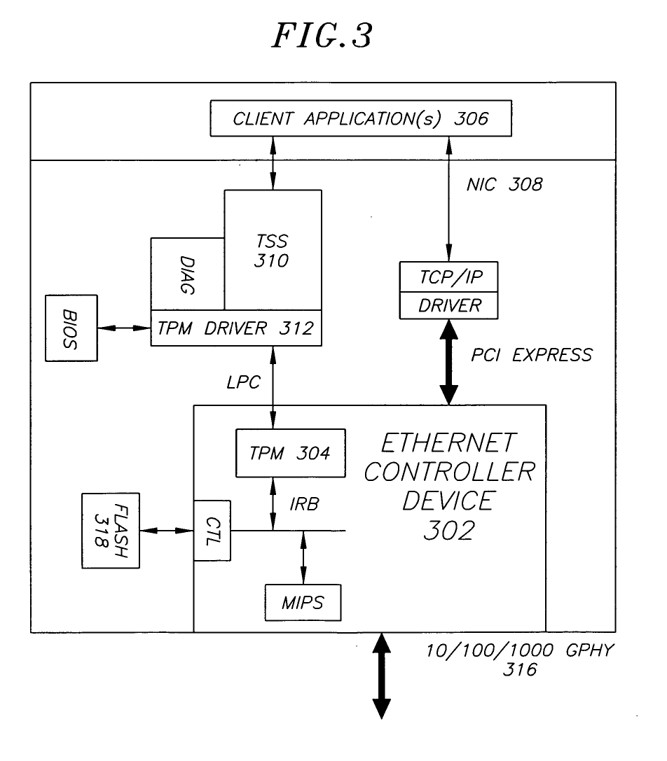

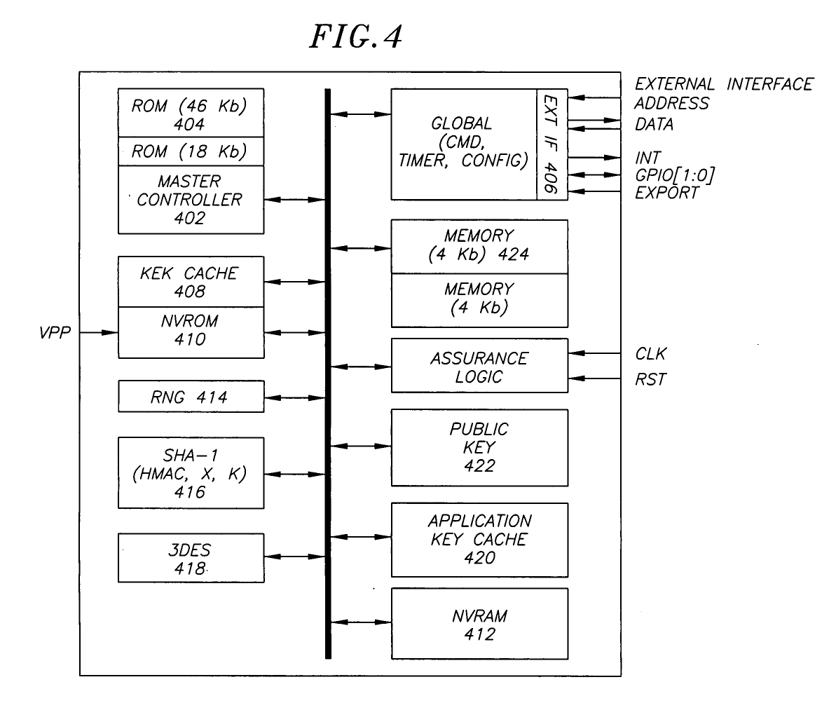

FIG. 2 depicts one embodiment of a system S incorporating a trusted platform module (“TPM”) 202 constructed according to the invention. In this example, the TPM consists of a secure processor (e.g., micro controller) subsystem embedded in an Ethernet controller device (e.g., a controller chip) as shown in FIGS. 3 and 4.

The Ethernet controller device may, in turn, be located on a network interface card or on a LAN-on-Motherboard solution, etc. (hereafter referred to as a “NIC” for convenience). Typically, the Ethernet controller device is initially manufactured and tested by an integrated circuit manufacturer. The chip is then sent to an OEM that places the chip onto a circuit board (e.g., a NIC), then tests the completed circuit board assembly.

Referring again to FIG. 2, one or more hardware security modules 204 provide key management for the system. Typically, the hardware security module provides high-level management of system keys including, for example, key distribution, key generation and enforcing key policies. Typically, a hardware security module must protect keys not just on a session basis, but must protect private keys for large organizations. Hence, security modules typically are very powerful and very secure devices (typically FIPS-140-2, certification level 2, 3 or 4).

The hardware security module communicates with the TPM to generate and publish the certificates 208 required for a TPM under the TCG specifications. Thus, applications 210 that need to communicate with the TPM may be assured by the certificates that the TPM is trusted pursuant to the TCG specifications.

The process of generating the certificates involves enrolling the TPM and binding the TPM to a specific platform. The enrollment process involves generating an RSA public/private endorsement key (“EK”) pair, securely storing the private EK in the TPM, and generating and publishing a certificate C_{EK} that authenticates the public EK. The binding process involves generating and publishing a platform certificate that binds and digitally signs the public EK with the identity of the platform. The platform may be identified many different ways including for example, using a serial number, a MAC address, etc.

In accordance with the teachings herein, the TPM device 202 may be enrolled in such a manner as to not require an OEM to provide either a secure environment for handling of keys, nor necessarily enroll the TPM during OEM manufacture. These aspects of the invention will now be treated in more detail after a brief discussion of conventional practice.

As discussed above, the TPM in this example is embedded on chip with an Ethernet controller device. Preferably the TPM follows the same manufacturing flow steps for the Ethernet controller device without placing a substantial additional burden on either the OEM or the Ethernet controller device manufacturer.

To enroll a TPM, the public key 206 of the TPM's endorsement key (EK) must be signed by a trusted third party (typically the OEM manufacture of the system). The manufacturer, therefore, must ensure that it only signs public keys of TPM devices which it trusts.

Conventionally, the TPM generates the corresponding private portion 218 of the EK internal to its security boundary. Since the generation of a private RSA key 218 (required by the TPM) is relatively time consuming on the TPM processor, the TCG specification allows for the value of the private EK 218 to be injected into the TPM secure boundary, provided that the value of the key is not exposed. This allows an external device such as a hardware security module that contains a high performance processor and hardware that can generate keys very quickly to do the key generation for the TPM.

As mentioned above, in addition to enrolling the TPM, in a conventional system the OEM binds the TPM to a specific platform in the form of a “platform certificate.” The TPM public key and the platform identity are bound and digitally signed to form a certificate specific for a properly manufactured platform (e.g., a PC) that contains a properly installed TPM.

The steps of enrolling and binding a TPM as practiced conventionally require a unique touch and unique values per platform. From the perspective of the OEMs, these additional and custom steps are undesirable.

In accordance with one embodiment of a system constructed according to the invention, the following process describes how the TPM and platform can be enrolled after the system has shipped to the customer, for example, at the time of installation of the supporting software. Briefly, the TPM is initially programmed with a Diffie-Hellman private/public key pair (“D-H keys”). This D-H key pair provides security comparable to an RSA key pair of similar size, yet requires significantly less processing.

In one embodiment, the HSM and TPM use the D-H keys to establish a secure channel. They then use the secure channel to enable the HSM to securely inject the EK into the TPM. The HSM then generates and publishes the appropriate certificates.

In another embodiment, the secure channel is not necessary. Here, the TPM may generate the EK, then use the D-H private key to sign the public EK and the platform identifier that are sent to the HSM. The HSM then generates and publishes the appropriate certificates. These two embodiments will be discussed in more detail below.

The processes and characteristics that immediately follow relate to the manufacture of the TPM device (e.g., the chip within which the TPM resides):
1) The TPM device is designed to support TPM enrollment commands of a secure protocol. One example of such commands is discussed below.
2) During package (e.g., chip) test, the TPM is programmed with, for example, a 256 b exponent and 2048 bit modulus Diffie-Hellman private public key pair.
3) The TPM may also generate a serial number for convenience in finding the public key value at a later time.
4) The D-H private key 214 (typically labeled “Kdi”) is generated by the TPM internally within the security boundary (never exposed).
5) The value of the D-H public key 220 is exported on the test floor by and signed using an HSM (which contains the TPM manufacturer's private key). The TPM manufacturer in this case is attesting to the fact that this public key corresponds to a private key that has been generated inside the security boundary of the TPM (thus, the private key has not been exposed).
6) The database of TPM public Kdi values 220 signed by the TPM manufacturer is made available publicly. This may be accomplished, for example, via the Internet, by distributing a CD, etc.

The processes and characteristics that immediately follow relate to the manufacture of the OEM Platform (e.g., circuit board):
1) The TPM device is installed in the OEM platform
2) The platform serial number (identifying information) 216 is loaded as a one time event into the TPM protected storage. For example, the TPM may store the information in encrypted and authenticated Flash memory 212 on the OEM board.
3) Here, the TPM is not bound to the platform. Rather, the binding may be easily performed by a diagnostic that is used to test the Ethernet controller and the TPM when it is installed. This operation may be performed in a similar manner as allocating a MAC address to the controller.

The certificate generation and key generation for both the EK and the platform certificate can be done at any time and in a non-secure environment once the above operations have been completed.

In one embodiment, this is accomplished using a secure connection:
1) The TPM exports the platform identifier (e.g., a serial number, etc.) signed by the TPM Kdi private key 214.
2) An HSM 204 (local or remotely connected, for example, via the Internet) verifies the signature of the TPM using the Kdi public key 220.
3) The HSM establishes a secure D-H connection with the TPM using a D-H exchange protocol.
4) The secure connection is used by the HSM to inject the private value of the TPM EK 218 (generated internal to the HSM) into the TPM.
5) The HSM delivers a certificate 208 for the TPM by signing the public value of EK 206.
6) Since the HSM has also verified that the platform is bound to the TPM, it can also verify that the serial number for the OEM is a valid TPM platform. The HSM can then generate the platform certificate (not shown) as well.

The above process allows the OEM system to be manufactured in the same manner as it is without the TPM installed. The TPM can be enabled at any point in either the manufacturing flow, or after shipment to the end user (for example on installation of the required software).

In an alternative embodiment, the keys and certificates may be generated without using a secure connection. Since these steps may be done by the end user, the TPM may generate its own EK and simply sign the EK public value with its Kdi private value. This would ensure that the HSM does not know the value of EK for the TPM, but the HSM can still generate a certificate for that TPM in the manner described above. In this embodiment, a secure protocol may not be required. The TPM simply signs the public key with Kdi-private and signs the platform identifier with Kdi-private for which Kdi-public was registered as part of the manufacturing flow.

One advantage of this embodiment is that the approximately two to fifteen minutes of key generation time is moved to each end user. As result, this time is not as critical (e.g., expensive for the OEM) as it is on the manufacturing floor. Thus, this embodiment may typically be used when the EK is generated during end user installation. The certificate generation is still required, but no secure connection between the two devices is required since no private key material is transferred.

One example of TPM initialization in a device will now be discussed. A secure processor may be used to provide a secure enrollment capability for initializing a TPM. The following commands may be supported when using the secure processor for enrollment of the TPM:
An “INIT_DEVICEKEY (authorization, configuration)” command initializes a unique device key in NVM. The authorization parameter may consist of the SHA1 digest of the manufactured configuration public key. The device specific configuration information may include the following information:
   0—DC_Export (0=Domestic, 1=Export)
   1—DC_DIS_UserStatus
   2—DC_DIS_RawRng
   3—DC_MOD_Size (0=2048, 1=1024)
   4—DC_RunSelfTest
   5—DC_EnableUserKeya
   6—DC_DIS_Auth
   8—SC_EN_LowFreq

The secure processor internally generates the key material for the device identity key and device confidentiality key. The non-volatile memory (“NVM”) in the chip is checked to ensure that it is blank and has not previously been programmed. The NVM is programmed with the appropriate values. A checksum is generated over all of the NVM data.
A “FIPS_CLR ( )” command may be used to disable the secure processor by programming the NVM array to “1” and “0” thereby disabling all states and clearing all information stored in the secure processor.
A “DEV_KDI_PUBLIC (options, *authorization, *configuration, *KeyData)” command may be used to report the device identity key public value. The authorization information may include the value of the root authorization server's identity public key hash stored in NVM. The configuration information may include the value of the configuration information that was programmed during device initialization. Typically this configuration information is not secret. The KeyData information may be the device identity public key. The secure processor exponentiates the DSS private key ‘x’ value from NVM using the fixed generator and modulus from ROM to generate the public key value.
A “DLIES_GEN_KS (kek_loc, challenge, *KeyData, *MsgSig)” command may be used to start a new key session using a Diffie-Hellman integrated encryption scheme (“DLIES”). The challenge information may be a server random data value. The KeyData information may be a key session client public key. The MsgSig information may be a secure processor signature of the session client public key and the server random value.
A “DLIES_MSG_DEC (cache, location, kek_loc, akey_loc, DLIES_Msg, *MsgID, *ksize)” command may be used to decrypt a DLIES message. The cache information may indicate a key encryption key (KEK) cache. The location information may indicate the location of the KEK cache used for the initial decryption. The kek_loc information may indicate the location of the KEK cache used for the decryption. The akek_loc information may indicate the location of an application key cache. The MsgID may be the final message ID returned to the local host. The ksize parameter may indicate the number of key cache locations used by this key.

A privacy (or confidentiality) key KDC is not required for TPM initialization using the secure processor. The TPM uses the KDC NVROM locations to store the 3DES and HMAC keys for covering external local secret data (never exposed to anyone outside the TPM). The “DLIES_MSG_DEC (cache, location, kek_loc, akey_loc, DLIES_Msg, *MsgID, *ksize)” command can be called multiple times prior to the installation of the “first” owner of the TPM (generation of the first SRK).

The TPM limits the use of this mechanism for the injection of the TPM endorsement key.

During the manufacturing process of the TPM, the “INIT_DEVICEKEY (authorization, configuration)” command is executed at final test. The public portion of the secure processor KDI is registered by the device manufacturer (signed into a certificate) as a valid manufactured TPM.

Once the TPM is installed into the user system, the HSM may at anytime, over any compatible type of network, inject the TPM endorsement key using the protocol.

FIG. 3 depicts one embodiment of an Ethernet controller 302 incorporating a trusted platform module 304 constructed according to the invention. Client applications 306 executing on a PC (not shown) use a NIC 308 to communicate over an Ethernet network such as the Internet (not shown).

The TPM provides a set of cryptographic capabilities that enable certain computer functions to be securely executed within the TPM hardware. The applications communicate with the TPM via a TPM software stack (“TSS”) 310 and TPM driver 312. The TPM driver communicates with the TPM in the Ethernet controller via a low pincount interface (“LPC”) 314. The TPM provides the required cryptographic operations to encrypt, decrypt and/or authenticate data that is sent to/received from the Ethernet network via a 10/100/1000 GPHY 316 or sent to/received from a data memory (e.g., flash 318).

FIG. 4 depicts one embodiment of a trusted platform module 400 constructed according to the invention. The TPM includes a master controller 402 (with associated ROM, e.g., ROM 404) for controlling the overall operation of the TPM. The TPM includes an external interface 406 for interfacing with other components in the Ethernet controller. The TPM includes several dryptography-related components including KEK cache 408, non-volatile ROM 410 and RAM 412, random number generator 414, SHA-1 hash processor 416, 3DES cryptography processor 418, various storage for keys 420, 422 and other data memory (e.g., memory 424). As discussed herein, the 3DES cryptography processor may perform cryptographic operations including, for example, encryption, decryption, authentication and key management. In the embodiment of FIG. 4, the components communicate via a bus 426.

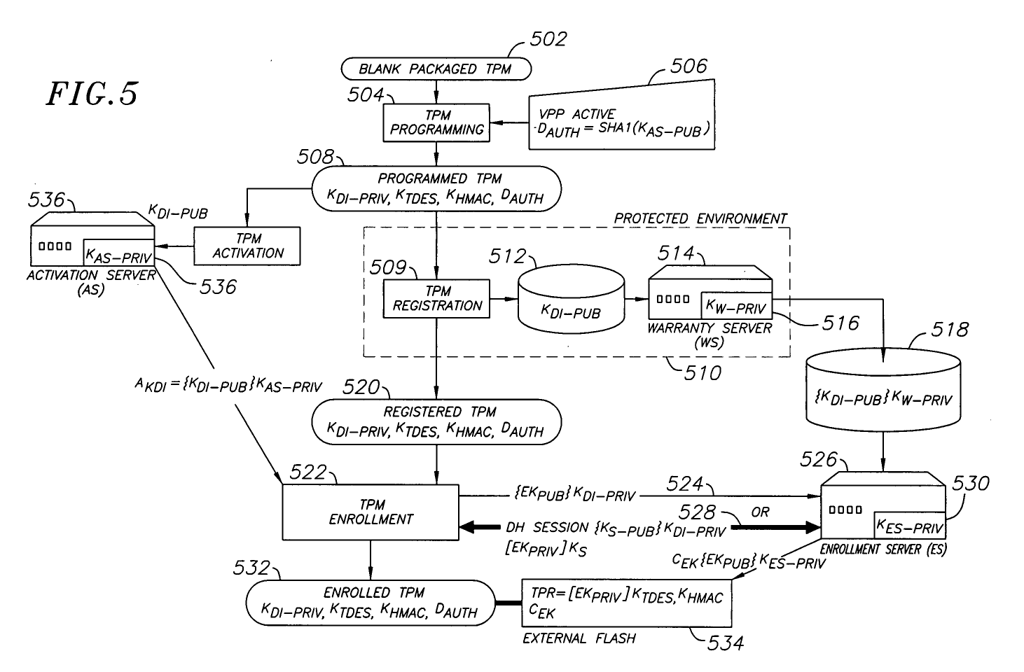

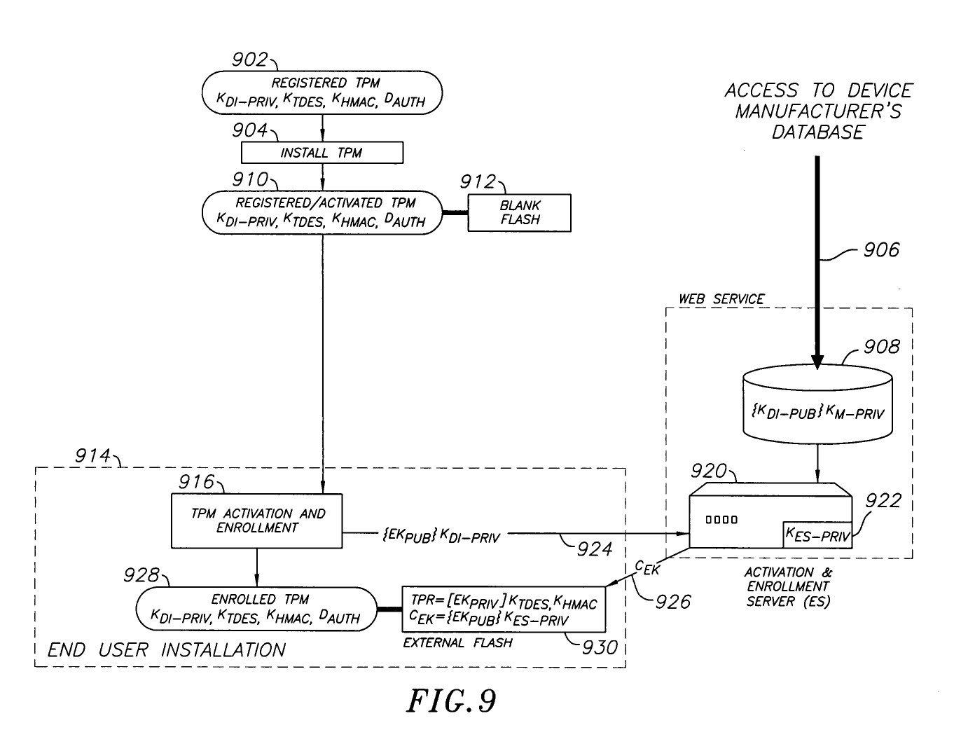

Referring to FIGS. 5-9 various examples of manufacturing flow and enrollment procedures for some embodiments of a TPM will be discussed in more detail.

In general, a TPM is a hardware protected environment that may be used for key management functions in a security system. The TPM provides secure (or sealed) storage for user keys by using asymmetric encryption based on a key hierarchy for the device. The TPM protects the clear text versions of asymmetric “private keys” within the hardware security boundary.

There are two main branches for key protection in a TPM: an endorsement key (“EK”) and a storage root key (“SRK”). The endorsement key is used for attestation of the TPM hardware protection. The storage root key is used for encryption of key material for storage outside the TPM boundary.

Since the TPM is required to endorse key material and platform authentication data (PCRs) using the EK, the EK is rooted in a Public Key Infrastructure. In other words, a certificate is generated that specifies that a particular EK belongs to a valid TPM. The certificate is a digital signature of and by the manufacturer of, for example, either the TPM or the TPM platform that indicates the private key portion of the EK is protected by certified TPM hardware.

The EK is specified as a 2048 bit RSA key pair (private, public key pair). The TCG specification allows the private key portion of the EK to either be generated directly by the TPM or “securely injected” into the TPM. If the key is securely injected into the TPM, the device that injects the private key must “forget” the private key value to ensure the integrity and privacy of the EK.

The TCG allows for key injection of the RSA private key due to the potentially long key generation time for an RSA 2048 bit key pair. The public key may be easily derived bases on the private key value. Since the TPM processing power is limited, the time may take, for example, on average about 2 minutes. However, due to prime checking requirements, the process could take as long as 15 minutes in some applications. This limitation may make it undesirable to generate the EK during the manufacturing process of the TPM.

As illustrated in FIG. 3, a TPM may be embedded into a processing device such as a Gigabit Ethernet controller chip. As shown in FIGS. 3 and 4, a TPM architecture as described herein may use a combination of internal one-time-programmable (“OTP”) memory (e.g., NVROM) and FLASH memory external to the chip for storage of nonvolatile data specific to the TPM.

In some embodiments, a TPM may incorporate two different OTP arrays located inside the protected hardware boundary of the TPM. For example, a first OTP may be used for storage of long term secure data programmed with the information in Table 1.

TABLE 1

| | |
|---|---|
| D_{AUTH} | Authorization data used to activate the TPM |
| D_{CFG} | Device Configuration Information |
| K_{TDES} | Unique Triple DES encryption key used for |
| | protection of locally stored NV data specific |
| | to the TPM |
| K_{HMAC} | Unique SHA1-HMAC authentication key used for |
| | protection of locally stored NV data specific |
| | to the TPM |
| K_{DI-PRIV} | Unique DSA Signature Key used to securely |
| | identify a specific TPM |

The D_{AUTH} and D_{CFG} may be presented to the TPM during programming of the first OTP to set the configuration or personality of a particular TPM device. The key values (K_{TDES}, K_{HMAC} and K_{DI-PRIV}) may be generated by the TPM using the internal true random number generator (e.g., as shown in FIG. 4) and appropriate post processing of random data per the required key generation specifications in FIPS. In some embodiments these key values are never accessible outside the hardware protected security boundary of the TPM.

A second OTP array may be used as a monotonic sequence number (C_{MSN}) for protection of data that is stored encrypted by the TPM. The TPM may use the combination of K_{TDES}, K_{HMAC} and the C_{MSN} to create a secure record that is encrypted using K_{TDES}, authenticated using K_{HMAC} and protected from replay using C_{MSN}. The data in this TPM protected record (“TPR”) may be stored using the external FLASH connected to the chip.

The TPR contains data that is unique to a particular TPM such as a TPM endorsement private key, a TPM storage root key, owner authorization, TPM nonvolatile flags, state information and C_{MSN}. The TPR is updated with a new sequence number each time the values in the TPR change to ensure that a previous state can never be replayed to the TPM by modifying local FLASH.

The first OTP array may be programmed during device manufacturing final test (after the device is packaged). Here, use of a DSA-based signature key allows for key generation time and programming time to be fixed during manufacturing test (e.g., in the 100 ms range). The second OTP may not be programmed during device manufacturing testing. For example it may not be initialized until the first TPR is generated by the TPM. Since the TPM described above uses FLASH for the storage of the TPR, the values stored in the TPR would, in general, be generated after the chip has been installed in a system containing the FLASH device.

FIG. 5 illustrates one embodiment of manufacturing flow for a TPM-based device (e.g., chip) that may be use to ensure the security of the device is not compromised. The process begins at block 502 with a TPM that has been is packaged but has not been programmed (i.e., it is blank).

As represented by block 504, the blank TPM is then programmed. The programming of the first OTP is typically done during final test for manufacturing the TPM.

As represented by block 506, the configuration and activation values (D_{AUTH}) may be programmed into the TPM using a standard test program. The public key (K_{AS-PUB}) of an activation server may be used to generate the D_{AUTH} values. The TPM generates the required keys (e.g., K_{DI-PRIV}, K_{TDES} and K_{HMAC}) internal to the security boundary. Thus the key values may never be exposed by the TPM. The high voltage pin VPP must be active during the programming process for the values to be burned into the OTP. As represented by block 508, after programming the K_{DI-PRIV}, K_{TDES}, K_{HMAC} and D_{AUTH} values may be securely stored in the device.

Block 509 represents the TPM registration process. In some embodiments registration of the TPM requires that the value of K_{DI-PUB} be entered into a secure database 512 that verifies the integrity of the manufactured TPM. The database may consist of a list of all valid manufactured TPM devices. The values of K_{DI-PUB} are collected in a manner that ensures it is difficult for someone to subvert the process and procedures used to manufacture the TPM devices for the purpose of registering public key values to which they know the private key pair.

The database of valid TPM public keys must be collected in a controlled secure environment as represented by block 510. Once collected, these public values can be transferred outside of that secure environment by using a warranty server 514 to sign the K_{DI-PUB} value to indicate that the K_{DI-PRIV} value was generated inside the hardware protected security boundary of a TPM. Here, the warranty server may use one or more private keys K_{W-PRIV} 516 to sign public keys K_{DI-PUB} that are stored in a public database 518.

The registration of K_{DI-PUB} is done in a manner that ensures it is difficult for someone to get an invalid K_{DI-PUB} registered. Thus, the registration effectively warranties the manufacturing processes and practices of the TPM device manufacturer or the TPM platform manufacturer (e.g., the OEM).

In some applications registration of the TPM may be done during the manufacturing process of the device (e.g., the chip). The TPM device initialization may be done during final test of the packaged device. In some embodiments this is initiated via a command that provides D_{AUTH} and D_{CFG}. This command may only be executed one time.

After the generation of K_{DI-PRIV}, the TPM provides K_{DI-PUB} to a warranty key server via a physically private connection. The warranty key server generates a warranty certificate indicating the K_{DI-PUB}, location, time, date, etc. of the manufactured device.

Typically, the warranty key server contains a tamper resistant protected hardware security module (“HSM”) to ensure the integrity of the private key (K_{W-PRIV}) used for warranting the devices. The private connection is physically secure via process and procedures for manufacturing the chip to ensure that invalid K_{DI-PUB} values are not submitted to the warranty key server.

The TPM includes a secret HMAC key (K_{B}) embedded in the ROM of the TPM inside the security boundary. The TPM reports both the value of the public key (K_{DI-PUB}) and an HMAC-SHA1 hash digest of the public key using the embedded secret key. The value of K_{B} is only known by the HSM that verifies the values signed by the warranty server. It should not be included in the HSM that is used on the test floor for signing the K_{DI-PUB} values of the TPM. Although this value may be constant across all of the TPM devices manufactured, someone would have to reverse engineer the internal ROM of the TPM and gain physical access to the test floor to insert an invalid public key.

The procedures in place for the protection of the warranty server (which would typically reside on the test floor within the test cage) may include the capability to revoke K_{W-PRIV} with a minimal window of exposure (limited amount of material required to be scrapped.

The protection of the K_{W-PRIV} may be enhanced using a second layer of signatures and certificates. The second layer of certificates may require that a batch of certificates for a particular wafer lot (or wafer lots) of devices is signed by a second manufacturing key K_{M-PRIV} to narrow the window of exposure in the event that K_{W-PRIV} is comprised through physical attack (i.e. the server is stolen and the integrity of K_{W-PRIV} is unknown). This may also be accomplished by remotely connecting the warranty server using a secure VPN, etc.

In some applications the TPM may be registered during the manufacturing process at the OEM using a similar process as performed by the device manufacturer as discussed immediately above. The procedure would again use a private connection to the key server via the methods outlined above.

The TPM registration in this case may be combined with the activation step that is discussed above in conjunction with TPM Registration. The activation of the TPM requires that the platform report the value of K_{DI-PUB} to an “authorized” server for signature and activation. Provided that the connection is a private secure connection, the authorization server can sign the K_{DI-PUB} generate the K_{DI-PUB} registration certificate.

Block 520 represents the TPM after registration. The K_{DI-PRIV}, K_{TDES}, K_{HMAC} and D_{AUTH} values are maintained securely within the device.

Next, as represented by block 522, the TPM is enrolled. The TPM uses the K_{DI} key pair as a unique identifier for a given TPM. The K_{DI} is used to securely bind an EK to a specific TPM and, in some embodiments, to a specific platform). The EK binding may be accomplished using this key pair by secure endorsement key injection or registration.

In secure endorsement key injection the K_{DI} key pair is used to authenticate the TPM to a secure enrollment server 526 in the establishment of a secure ephemeral Diffie-Hellman (“DH” ) session as represented by line 528. The secure key server 526 uses the DH session to transfer the private key portion of the EK (EK_{PRIV}) into the security boundary of the TPM. Here, 3DES and HMAC-SHA1, for example, may be used to protect the data transferred to the TPM.

Since the private keys are generated on the secure server in a protected environment such as a hardware security module, the key generation may be done on a much faster processor to cut the time required for EK private key generation during the manufacturing process. The secure session allows the transfer of the private portion of EK (EK_{PRIV}) to be done over a public connection between the secure key server and the TPM.

There does not need to be an authentication of the secure server by the TPM since the secure server issues the certificate for the EK. Since the secure server generates the EK certificate at the same time as the private key portion of the EK, the TPM does not need to verify the authenticity of the secure server. However, the secure server must be assured that a particular TPM can protect the EK private key properly. This requires that the secure key server verify the identity of the TPM via K_{DI-PUB}.

Therefore, the value of K_{DI-PUB} is transferred to the secure key server in such a manner that ensures the integrity of the TPM protection boundary. For this EK generation model, two ways to accomplish the transfer of K_{DI-PUB} to the secure key server will be mentioned. The first method is for the value of K_{DI-PUB} to be registered during the manufacturing process as discussed above.

The second method would involve a private connection between the TPM and the secure key server that ensures the integrity of the value of K_{DI-PUB}. The trust in EK is tied to the assurance that someone cannot get a secure key server to issue a certificate for a TPM that does not properly protect the private key of the EK. Using this method effectively registers the value of K_{DI-PUB} at the same time as the keys are transferred to the TPM.

In secure endorsement key injection the generation of the EK is done by the TPM inside the secure protected hardware boundary. The K_{DI-PRIV} is used by the TPM to sign the combination of the platform identifier (serial number, vendor data, etc.) and the EK public key. The EK private key is thus bound to the unique TPM identified by K_{DI}. The platform identifier is provided to the TPM by software during the signature process as “authorization” for the generation of the certificate of a particular platform.

As represented by line 524 the TPM sends the EK public value signed by K_{DI-PRIV} to a secure enrollment server 526. The signed EK public value EK_{PUB} is verified by the secure key server 526 that then generates a TPM EK certificate (C_{EK}). That is, the server 528 signs EK_{PUB} using the enrollment server's private key K_{ES}_{_{—}}_{PRIV} 530.

The secure key server must verify the integrity of the TPM using the registered K_{DI-PUB}. Therefore, the value of K_{DI-PUB} must be transferred to the secure key server in such a manner that ensures the integrity of the TPM protection boundary. This may be accomplished, for example, as discussed above.

The generation of the EK private value may still involve a relatively long key generation time since it is generated inside the TPM. However, the generation of this key value may be done during a non-time critical process. For example, the generation of EK can be accomplished at anytime after the TPM has been activated and FLASH is installed local to the device.

The EK certificate may be generated separate from the generation of EK. For example, the EK may be generated during platform diagnostics after activation and software installation. However, the generation of the EK certificate may be done after the platform has been shipped to the end user.

The EK generation need only be done prior to the generation of the EK certificate. In some embodiments the EK is generated by the end user. Since other keys may need to be generated (e.g., SRK generation) when taking ownership of the TPM system, the time involved may not significantly impact the user experience. The EK certificate generation may also be user optional in this case.

The TPM requires a secure activation command to be issued before the TPR is generated. For example, the TPM may remain in a “disabled” state (with a limited set of valid commands) until the secure activation command is issued. A sequence number may be included with the activation command to ensure that a previous activation command cannot be replayed to the same TPM.

The secure activation command requires that an authorized server (e.g., activation server 536) sign the public key (K_{DI-PUB}) of the TPM. Here, the activation server 536 signs K_{DI-PUB} with its private key K_{AS-PRIV} 536. The signature A_{KDI} (i.e., the activation record for this particular TPM) is verified by the TPM using the public key of the authorized server 536. The identity of the authorized server may be validated by the TPM using the D_{AUTH} from the first OTP array.

The activation is a proof to the TPM that the TPM can be utilized on the platform. The activation is a one-time event in the life of a TPM (as is the generation of the EK). Once the second OTP array has been programmed the TPR is kept in sequence by the TPM.

The activation of the TPM is unique for each TPM since it requires the signature of the K_{DI-PUB} key by the authorized server. The authorized server may be used to track the number of enabled TPM platforms for purposes of software licensing. The TPM may provide the capability to bypass this step using a default D_{AUTH} during manufacturing. Here, the device is ordered as a device in which the TPM is activated. In this case, the tracking may be done per activated part.

The activation server 536 is secure since it must protect the private key used to sign the TPM public key value. However, but the connection between the TPM and the activation server does not need to be private.

After the TPM has been enrolled (block 532) and activated, TPR may be programmed in external flash memory with EK_{PRIV} encrypted by K_{TDES}, K_{HMAC} and C_{EK} (block 534).

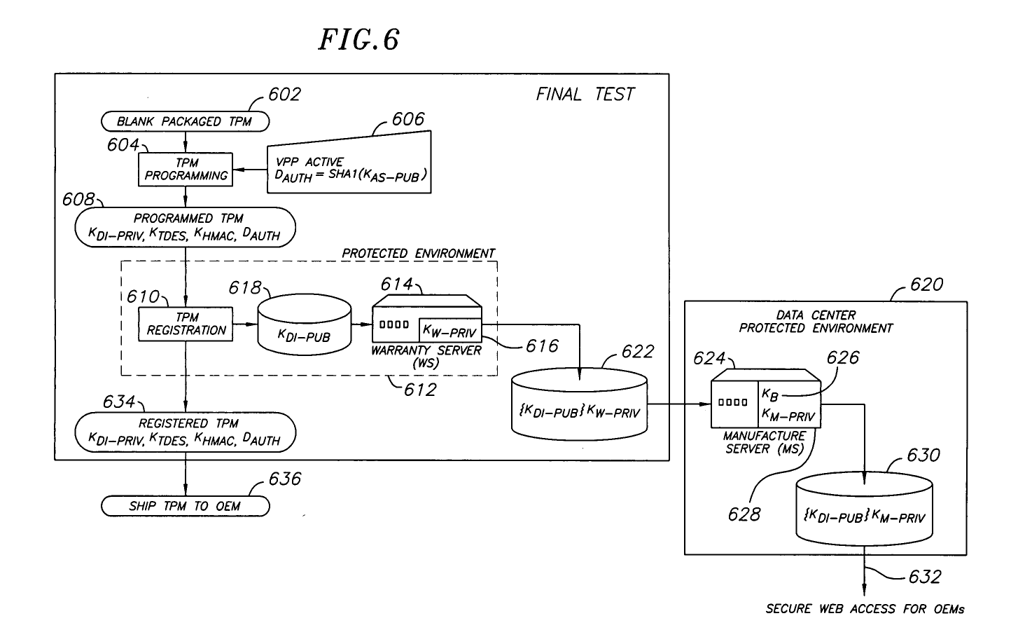

FIG. 6 illustrates one embodiment of TMP manufacturing flow for the TPM-based device (e.g., chip) starting with a blank packaged TPM (block 602). At block 604 the device is programmed, for example, during the final test of the device by activating VPP and providing the D_{AUTH} value (block 606).

As represented by blocks 608 and 610, the TPM is registered after programming. The registration process is performed in a protected environment as represented by block 612. For example, a warranty server 614 may be mounted in cage with the device tester. Registration may be monitored via process and procedures to ensure that the warranty server is not stolen. Access to the cage may be controller, for example, via the use of audit log.

The warranty server contains an HSM to protect the warranty server's private key K_{W-PRIV} 616. The warranty server signs K_{DI-PUB} from the database 618 with its K_{W-PRIV} 616 and stores the signed value ({K_{DI-PUB}} K_{W-PRIV}) in a warranty database 622.

The signed value is transferred from the database 622 via a virtual private network (“VPN”) to the device manufacturer's controlled data site 620. A manufacture server 624 located at controlled site 620 verifies the K_{B} 626 and K_{W} signature values and signs K_{DI-PUB} with K_{M} (i.e., K_{M-PRIV} 628). Here, K_{B} is the manufacturer's integrity key. The manufacture's database 630 thus stores {K_{DI-PUB}}K_{M-PRIV}. This information may be accessed by the OEM via, for example, Internet access as represented by line 632.

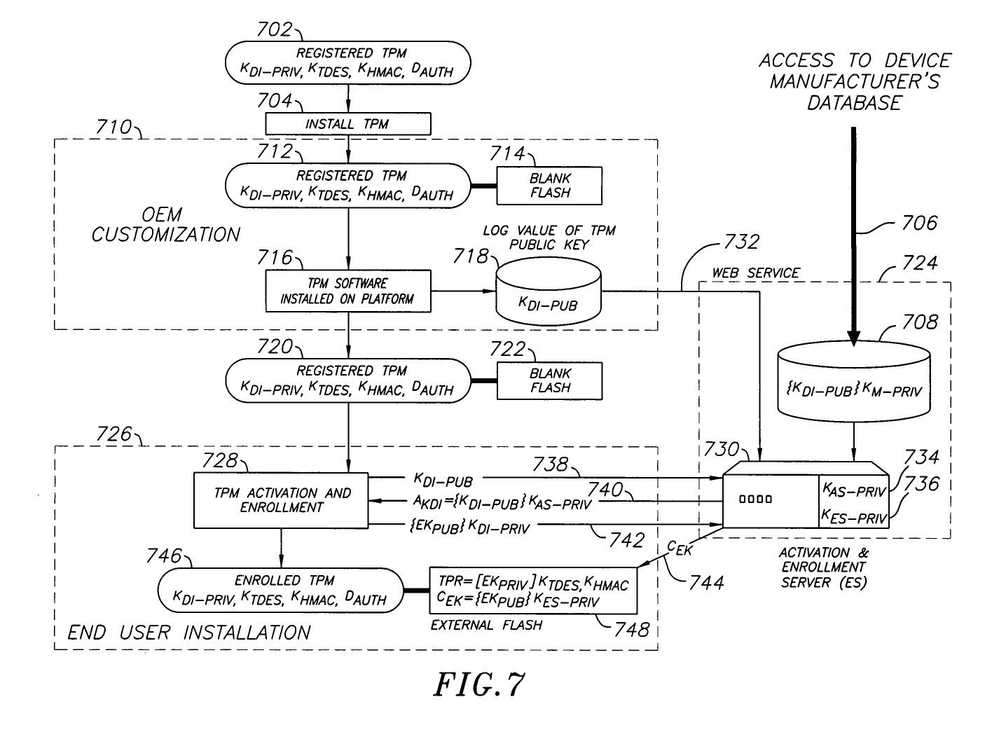

As represented by blocks 634 and 636, after the TPM is registered, the device is shipped to the OEM. FIGS. 7, 8 and 9 illustrate three different embodiments of OEM manufacturing flow. Each of these processes starts with a registered TPM as discussed above.

In the embodiment of FIG. 7 a user activates and enrolls the TPM. A registered TPM (block 702) is installed into a product (e.g., a NIC) as represented by block 704. As represented by line 706, access is provided to the device manufacturer's warranty database 708 which contains {K_{DI-PUB}}K_{M-PRIV}.

During the OEM customization process (block 710) the registered TPM 712 is paired with a blank flash memory 714. The OEM then installs the TPM software on the platform (block 716). The OEM then stores the TPM public key values K_{DI-PUB} for that platform (e.g., an authorized TPM) in a database 718.

The OEM product with the registered TPM 720 and blank flash 722 are then shipped to the end user. The activation and enrollment service (provided by a combined server) may then be provided as a web service 724. Thus, user install of the device (block 726) may require a web connection to activate software and enroll the TPM (block 728).

The OEM provides a list of the installed TPM systems to the activation and enrollment server 730. As represented by line 732 this information is provided in the form of the K_{DI-PUB} values from the database 718. As discussed above, the activation server maintains K_{AS}_{_{—}}_{PRIV} 734 and the enrollment server maintains K_{ES-PRIV} 736 for their respective operations.

Activation occurs in response to a request from a user to access the activation key for the TPM. This request includes the public key K_{DI-PUB} for the TPM. The server verifies that the request is for an authorized TPM (e.g., the public key value K_{DI-PUB} matches a K_{DI-PUB} from the list provided to the server by the OEM as discussed above) . If so, as discussed above the activation server returns the activation record A_{KDI} 740 to the user (line 740).

Enrollment occurs in response to a request 742 from a user to obtain a certificate for EK. For example, the user's installation software may sign EK_{PUB} using K_{DI-PRIV}. The enrollment server 730 verifies the K_{DI-PUB} with the manufacturer database {K_{DI-PUB}}K_{M} 708. The enrollment server verifies the K_{DI-PUB} value with the OEM list of authorized TPM systems. If all of the checks pass, the enrollment server issues a certificate for EK (C_{EK}) as represented by line 744.

After the TPM has been enrolled (block 746) and activated, the TPR may be programmed in the flash memory with EK_{PRIV} encrypted by K_{TDES}, K_{HMAC} and C_{EK} (block 748).

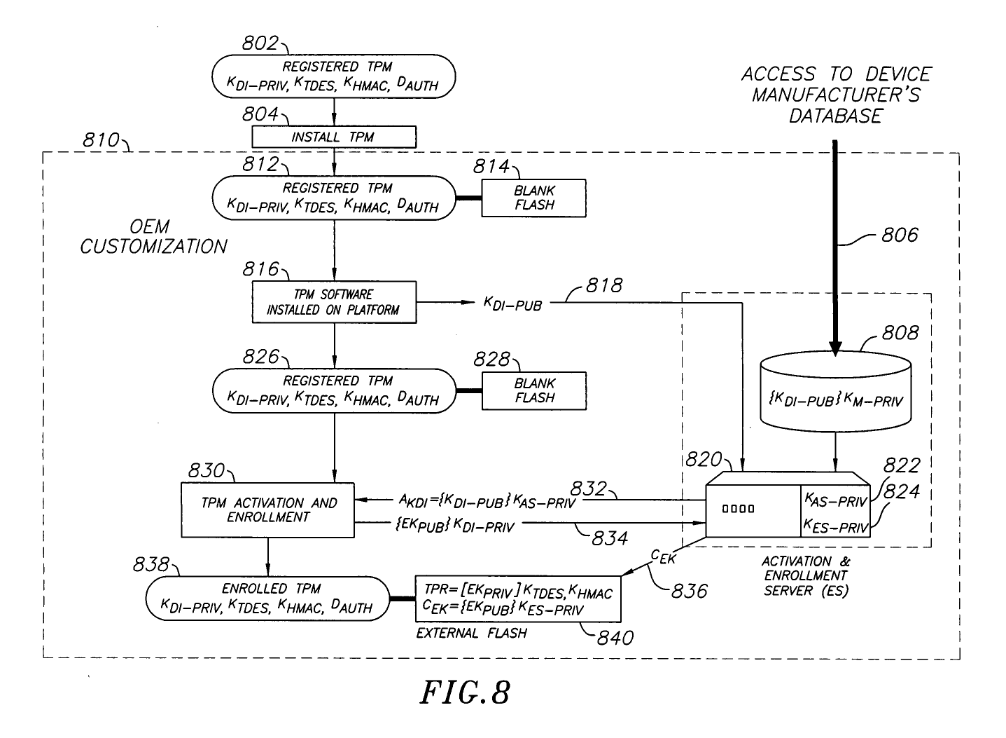

FIG. 8 illustrates an embodiment where the OEM activates and enrolls the TPM. A registered TPM (block 802) is installed into a product (e.g., a PC motherboard) as represented by block 804. As represented by line 806, the OEM has access to the device manufacturer's warranty database 808 which contains {K_{DI-PUB}}K_{M-PRIV}.

During the OEM customization process (block 810) the registered TPM 812 is paired with a blank flash memory 814. The OEM then installs the TPM software on the platform (block 816). As represented by line 818 the OEM provides the TPM public key values K_{DI-PUB} for that platform (e.g., an authorized TPM) to an activation and enrollment server 820.

The OEM product with the registered TPM 826 and blank flash 828 is then activated and enrolled (block 830) by the OEM. In this embodiment the server 820 is maintained in the OEM factory. As discussed above, the activation server maintains K_{AS}_{_{—}}_{PRIV} 822 and the enrollment server maintains K_{ES-PRIV} 824 for their respective operations.

Activation occurs when the OEM installs software and makes a connection to the activation server 820. In this case, the activation record A_{KDI} received from the server 820 (as represented by line 832) is stored on the product by the OEM.

Enrollment occurs in response to a request 834 from the OEM to obtain a certificate for EK. For example, the OEM enrollment software may sign EK_{PUB} using K_{DI-PRIV}. The enrollment server 820 verifies the K_{DI-PUB} with the manufacturer database {K_{DI-PUB}}K_{M} 808. The enrollment server verifies the K_{DI-PUB} value with the OEM list of authorized TPM systems. If all of the checks pass, the enrollment server issues a certificate for EK (C_{EK}) as represented by line 836. To compromise the security of this procedure an individual would need access to the K_{B} secret key (reverse engineering the ROM code), access to the device manufacturer's manufacturing floor (ability to insert K_{DI-PUB} into the warranty server) and access to the, OEM manufacturing flow (ability to insert K_{DI-PUB} as an authorized TPM).

After the TPM has been enrolled (block 838) and activated, the TPR may be programmed in the flash memory with EK_{PRIV} encrypted by K_{TDES}, K_{HMAC} and C_{EK} (block 840).

In the embodiment of FIG. 7 a user activates and enrolls the TPM. However, activation occurs automatically when the software is initially installed by the end user.

Initially, the OEM orders a part number of TPM that is activated during the device manufacturer's manufacturing process. During final test the TPM is programmed with D_{AUTH} using a default K_{AS-PUB} value. The installation software to be used by the end user contains the default K_{AS-PRIV} value used to generate the activation signature on the platform.

The registered/activated TPM (block 902) is then installed into a product (e.g., a PC motherboard) as represented by block 904. The registered/activated TPM 910 is paired with a blank flash memory 912 and shipped to an end user.

User installation of the device requires a web connection to activate software and enroll the TPM device. When the end user first installs the product (block 914), activation (block 916) occurs automatically. This procedure is performed, for example, by the installation software on the platform.

To enroll the TPM (block 916) an end user accesses the enrollment service which is provided as a web service 918. As represented by line 906, access is provided to the device manufacturer's warranty database 908 which contains {K_{DI-PUB}}K_{M-PRIV}. The OEM provides a list of the installed TPM systems to the enrollment server 920. As discussed above, the enrollment server maintains K_{ES-PRIV} 922 for its operations.

Enrollment occurs in response to a request (line 924) from an end user to obtain a certificate for EK. For example, the user's installation software may sign EK_{PUB} using K_{DI-PRIV}. The enrollment server 920 verifies the K_{DI-PUB} with the manufacturer database {K_{DI-PUB}}K_{M} 908. The enrollment server verifies the K_{DI-PUB} value with the OEM list of authorized TPM systems. If all of the checks pass, the enrollment server issues a certificate for EK (C_{EK}) as represented by line 926.

After the TPM has been enrolled (block 928) and activated, the TPR may be programmed in the flash memory with EK_{PRIV} encrypted by K_{TDES}, K_{HMAC} and C_{EK} (block 930).

Service may be simplified for products manufactured using this process because the activation server does not need to be contacted to de-activate a TPM then reactivate a subsequent TPM. Access to the activation server from a service center is not required in this model.

From the above it should be appreciated that these techniques may be applied to many different embodiments. For example, these techniques may be used in a variety of secure environments other than a TPM. These techniques may be used to add any type of key to a secure platform and generate corresponding certificates. For example, these techniques may be used for subsequently added keys and certificates. One example is keys that are lower in the hierarchy such as corporate-wide signing keys.

It should also be appreciated that these techniques may be implemented in a variety of ways. Different embodiments of the invention may include a variety of hardware and software processing components. In some embodiments of the invention, hardware components such as controllers, state machines and/or logic are used in a system constructed in accordance with the invention. In some embodiment of the invention, code such as software or firmware executing on one or more processing devices may be used to implement one or more of the described operations.

Such components may be implemented on one or more integrated circuits. For example, in some embodiments several of these components may be combined within a single integrated circuit. In some embodiments some of the components may be implemented as a single integrated circuit. In some embodiments some components may be implemented as several integrated circuits.

The components and functions described herein may be connected/coupled in many different ways. The manner in which this is done may depend, in part, on whether the components are separated from the other components. In some embodiments some of the connections represented by the lead lines in the drawings may be in an integrated circuit, on a circuit board and/or over a backplane to other circuit boards. In some embodiments some of the connections represented by the lead lines in the drawings may comprise a data network, for example, a local network and/or a wide area network (e.g., the Internet).

The signals discussed herein may take several forms. For example, in some embodiments a signal may be an electrical signal transmitted over a wire while other signals may consist of light pulses transmitted over an optical fiber. A signal may comprise more than one signal. For example, a differential signal comprises two complementary signals or some other combination of signals. In addition, a group of signals may be collectively referred to herein as a signal.

Signals as discussed herein also may take the form of data. For example, in some embodiments an application program may send a signal to another application program. Such a signal may be stored in a data memory.

A wide variety of devices may be used to implement the data memories discussed herein. For example, a data memory may comprise Flash memory, one-time-programmable (OTP) memory or other types of data storage devices.

The components and functions described herein may be connected/coupled directly or indirectly. Thus, in some embodiments there may or may not be intervening devices (e.g., buffers) between connected/coupled components.

In summary, the invention described herein generally relates to an improved certification techniques. While certain exemplary embodiments have been described above in detail and shown in the accompanying drawings, it is to be understood that such embodiments are merely illustrative of and not restrictive of the broad invention. In particular, it should be recognized that the teachings of the invention apply to a wide variety of systems and processes. It will thus be recognized that various modifications may be made to the illustrated and other embodiments of the invention described above, without departing from the broad inventive scope thereof. In view of the above it will be understood that the invention is not limited to the particular embodiments or arrangements disclosed, but is rather intended to cover any changes, adaptations or modifications which are within the scope and spirit of the invention as defined by the appended claims.

1. A method of certifying a secure platform comprising:
manufacturing a platform;
generating a public/private key pair within the platform after the platform is manufactured; and
authenticating the platform and the public key.

2. The method of claim 1 wherein the platform is a TPM.

3. The method of claim 1 wherein the key pair is an RSA key pair.

4. The method of claim 1 wherein the key pair is generated within a secure boundary.

5. The method of claim 1 wherein the private key is always maintained with a secure boundary.

6. The method of claim 5 wherein the private key is output from the platform only in encrypted form.

7. The method of claim 1 wherein the key pair is generated during system test.

8. The method of claim 1 wherein the key pair is generated by an end user.

9. The method of claim 8 wherein the key pair is generated when the platform is installed.

10. The method of claim 1 wherein the platform is manufactured at a secure facility.

11. The method of claim 1 wherein the public key is associated with an identifier of the platform.

12. The method of claim 11 wherein the public key is associated with a serial number of the platform.

13. A method of certifying a secure platform comprising:
manufacturing a platform;
shipping the platform to a user;
generating a public/private key pair within the platform when the platform is installed by the user; and
authenticating the platform and the public key.

14. The method of claim 13 wherein the platform is a TPM.

15. The method of claim 13 wherein the key pair is an RSA key pair.

16. The method of claim 13 wherein the key pair is generated within a secure boundary.

17. The method of claim 13 wherein the private key is always maintained with a secure boundary.

18. The method of claim 17 wherein the private key is output from the platform only in encrypted form.

19. The method of claim 13 wherein the key pair is generated when the platform is installed.

20. The method of claim 13 wherein the platform is manufactured at a secure facility.

21. The method of claim 13 wherein the public key is associated with an identifier of the platform.

22. The method of claim 21 wherein the public key is associated with a serial number of the platform.
